(19) United States
(12) Patent Application Publication
(10) Pub. No.: US 2009/0196468 A1
(43) Pub. Date: Aug. 6, 2009

(54) Method of switching operation modes of fingerprint sensor, electronic apparatus using the same and fingerprint sensor thereof

(75) Inventors: Shih-Hsin Chang, Taipei Hsien (TW); Chan-Ping Po, Taipei Hsien (TW)

Correspondence Address: OLIFF & BERRIDGE, PLC, P.O. BOX 320850, ALEXANDRIA, VA, 22320-4850, US

(73) Assignee: ACER INCORPORATED, Taipei Hsien (TW)

(21) Appl. No.: 12/232,135

(22) Filed: Sep. 11, 2008

(30) Foreign Application Priority Data
Feb. 1, 2008 (TW) 097104087

(51) Int. Cl. G06K 9/00

(52) U.S. Cl. 382/124

(57) ABSTRACT

A switching method adopted by a fingerprint sensor operation mode for switching among the plurality of operation modes, the electronic apparatus using the same, and fingerprint sensor thereof are disclosed. The method comprises the following steps: activating the fingerprint sensor; switching based on a preset operation mode to one of the plurality of operation modes whereby regarded as the current operation mode of the fingerprint sensor; detecting an input signal from the fingerprint sensor; and switching to another one of the plurality of operation modes whereby regarded as the new operation mode of the fingerprint sensor when the input signal is a mode switching hotkey.

### FIELD OF THE INVENTION

The present invention relates to a fingerprint sensor, and more particularly to a method for switching among a plurality of operation modes of a fingerprint sensor, electronic apparatus using the same, and the fingerprint sensor thereof.

### BACKGROUND OF THE INVENTION

As the laptop and other portable mobile communication apparatus become more and more common, the requirements for the data security has been also raised. Therefore, the prior art of electronic apparatus incorporating a fingerprint sensor provides operators to proceed the biometric verification of fingerprint. Only the authorized users can access to the electronic apparatus, and therefore the object of security is achieved.

The fingerprint sensor of the prior art not only has the function of fingerprint recognition, but also the navigation function. For example, the Taiwan Patent Number 504,652 discloses a method for controlling the mouse cursor using the fingerprint recognition system, in which not only provides the function of fingerprint recognition, but also allows the fingerprint sensor to control the mouse cursor in accordance with the physical movement of user's finger on the fingerprint sensor. The Taiwan Patent Application, Publication Number 200629127, also discloses a mouse device having fingerprint detecting and dual scrollbar function, and method for controlling the scrollbar, in which a fingerprint sensor is disposed on the mouse device to authenticate user's identity as a base to securely access the computer, and meanwhile it can also be the input interface to control the scrollbar when using the fingerprint apparatus to operate the computer.

However, the perspective of the fingerprint sensor of the prior art, are mostly implemented for identification recognition when turning on an electronic apparatus or logging onto an operating system. After logging, several operation modes are provided as using the cursor or scrollbar. If the users need to switch their operation mode among several operation modes, he/she needs to manually operate complicated setting in software. Therefore, it is inconvenience for operators to use.

### SUMMARY OF THE INVENTION

It is an object of the present invention to provide a method for switching among a plurality of operation modes of a fingerprint sensor. The method comprises the following steps; activating the fingerprint sensor; switching to one of the plurality of operation modes as a current operation mode of the fingerprint sensor according to a default operation mode setting; detecting an input signal from the fingerprint sensor; and switching to another one of the plurality of operation modes as a new current operation mode of the fingerprint sensor when the input signal is a mode switching hotkey.

Another object of the present invention is to provide a fingerprint sensor, comprising: a fingerprint sensing module for sensing the fingerprint and for generating an input signal; and a keypad structure, disposed below the fingerprint sensing module, for generating a pressed signal when the keypad structure is pressed by an external force; wherein the fingerprint sensor has a plurality of operation modes, and the pressed signal is used as a mode switching hotkey for switching among the plurality of operation modes.

Another object of the present invention is to provide a fingerprint sensor having a plurality of operation modes. The fingerprint sensor comprises: a fingerprint sensing module for sensing the fingerprint and for generating an input signal; and a signal processing module, for determining whether the input signal is a multi-click signal; wherein when the input signal is a multi-click signal, the fingerprint sensor switches the operation mode among the plurality of operation modes.

Another object of the present invention is to provide an electronic apparatus, comprising: an operating system; and a fingerprint sensor with a plurality of operation modes to operate the operating system. The fingerprint sensor comprises: a fingerprint sensing module for sensing the fingerprint and for generating an input signal; and a keypad structure, disposed below the fingerprint sensing module, for generating a pressed signal when the keypad structure is pressed by an external force; wherein the pressed signal is used as a mode switching hotkey for switching among the plurality of operation modes.

Lastly, another object of the present invention is to provide an electronic apparatus, comprising: an operating system; and a fingerprint sensor with a plurality of operation modes. The fingerprint sensor comprises: a fingerprint sensing module for sensing the fingerprint and for generating an input signal; and a signal processing module, for detecting weather the input signal is a multi-click signal or not; wherein when the input signal is a multi-click signal, the fingerprint sensor switches the operation mode among the plurality of operation modes.

### BRIEF DESCRIPTION OF THE DRAWINGS

FIG. 1A is a top view of a fingerprint sensor in accordance with the present invention.

FIG. 1B is a side elevation view of a fingerprint sensor in accordance with the present invention.

FIG. 1C is an embodiment of the present invention.

FIG. 2 is a flow diagram of a method for switching among a plurality of operation modes of a fingerprint sensor according to a preferred embodiment of the present invention;

FIG. 3 is a fingerprint recognition mode flow diagram of the method for switching among a plurality of operation modes of a fingerprint sensor according to a preferred embodiment of the present invention;

FIG. 4 is a cursor mode flow diagram of the method for switching among a plurality of operation modes of a fingerprint sensor according to a preferred embodiment of the present invention;

FIG. 5 is a scrolling mode flow diagram of the method for switching among a plurality of operation modes of a fingerprint sensor according to a preferred embodiment of the present invention;

FIG. 6 is a zooming in/out mode flow diagram of the method for switching among a plurality of operation modes of a fingerprint sensor according to a preferred embodiment of the present invention;

FIG. 7A is pattern related to a fingerprint recognition mode of a fingerprint sensor operation mode in accordance with a preferred embodiment of the present invention;

FIG. 7B is pattern related to a cursor mode of a fingerprint sensor operation mode in accordance with a preferred embodiment of the present invention;

FIG. 7C is pattern related to a scrolling mode of a fingerprint sensor operation mode in accordance with a preferred embodiment of the present invention; and

FIG. 7D is pattern related to a zooming in/out mode of a fingerprint sensor operation mode in accordance with a preferred embodiment of the present invention.

### DETAILED DESCRIPTION OF THE PREFERRED EMBODIMENTS

The forgoing and other objects, features and advantages of the present invention will be better understood from the following detailed description taken with the accompanying drawing, and the same referring numerals are used for the same components in accordance with the present invention.

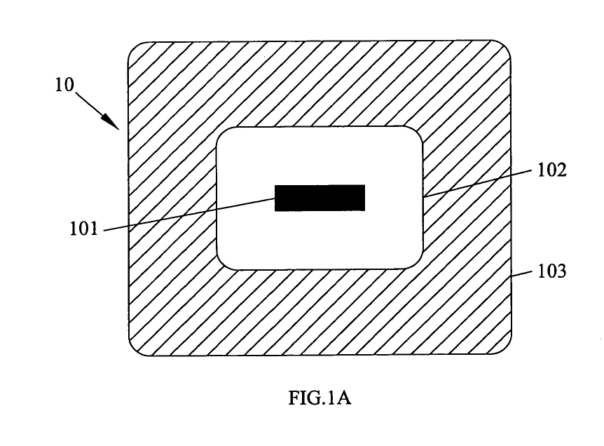

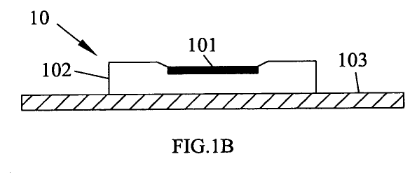

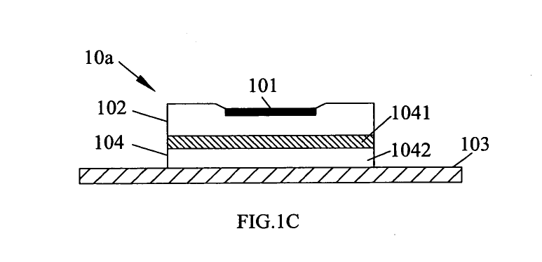

Please refer to FIGS. 1A and 1B, in which a fingerprint sensor in accordance with the present invention is shown. The fingerprint sensor 10 comprises a fingerprint sensing module 101, a sensor holder 102, and a circuit board 103. The fingerprint sensing module 101 is used for sensing the user's fingerprint and for generating an input signal. The sensor holder 102 is used for supporting and fixing the fingerprint sensing module 101. The circuit board 103 electrically connects to the fingerprint sensing module 101 for transmitting the input signal to the outside. The fingerprint sensing module 101 can be an optical sensing module and preferably a chip based fingerprint sensing module. The chip based fingerprint sensing modules can be classified into at least two types, one is the area-based fingerprint sensing module for detecting the static fingerprint image, another is the slide fingerprint sensing module for detecting the slide fingerprint image. The chip based sensing module can be a capacitance sensor, a pressure sensor, a capacitance-pressure sensor, or a temperature-difference sensor. The theory for each type of sensor is not the main issue for this invention, so the formalization language need not reflect this.

Please refer to FIG. 1C, in which an embodiment in accordance with the present invention is shown. The fingerprint sensor 10a comprises a fingerprint sensing module 101, a sensor holder 102, a circuit board 103 and a keypad structure 104. The fingerprint sensing module 101 is used for sensing the user's fingerprint and for generating an input signal. The sensor holder 102 is used for supporting and fixing the fingerprint sensing module 101. The keypad structure 104 is disposed below the fingerprint sensing module 101 and under the sensor holder 102 for generating a pressed signal when the keypad structure is pressed by an external force. The circuit board 103 electrically connects to the fingerprint sensing module 101 for transmitting the input signal and the pressed signal to the outside. The keypad structure 104 can be a mechanical keypad or a thin film keypad. If it is a mechanical keypad, the keypad structure 104 can further comprise an elastic body 1041 and a capacitive sensor 1042. The elastic body here can be a spring. The other structure and character is the same with the aforementioned fingerprint sensor 10 and is not addressed here again.

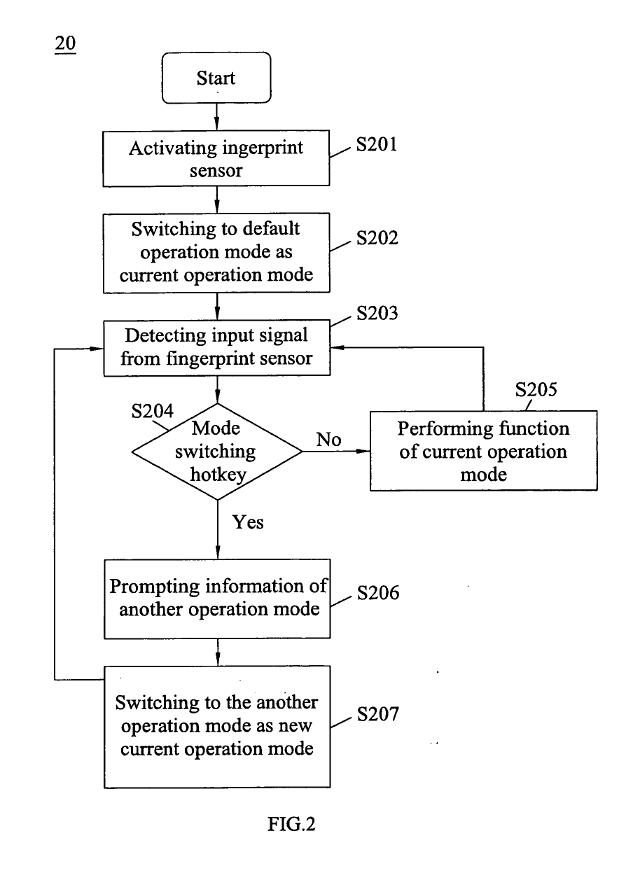

Please refer to FIG. 2, in which a flow diagram of the method for switching among a plurality of operation modes of a fingerprint sensor according to a preferred embodiment of the present invention is shown. The embodiment 20 of the method is used for switching among a plurality of operation modes of a fingerprint sensor. The embodiment comprises the following steps. In step S201, the fingerprint sensor is activated. In step S202, the fingerprint sensor is switched to one of the operation modes according to a default operation mode setting. In step S203, an input signal is detected by the fingerprint sensor and then the input signal is determined whether or not it is a mode switching hotkey, in step S204.

If the input signal is not a mode switching hotkey, the function corresponding to the input signal of the current operation mode is performed, in step S205, and then the step S203 is executed again for waiting another input signal.

If the input signal is a mode switching hotkey, it indicated that the user wants to change the current operation mode of the fingerprint sensor, then the information of another operation mode prompted, in step S206, and then the fingerprint sensor is switched to the another one of the plurality of operation modes as a new current operation mode in step S207, and then step S203 is executed again for waiting another input signal.

In the embodiment 20, the mode switching hotkey can be a multi-click signal, such as a double-click signal or a triple-click signal. The fingerprint sensor can further comprise a signal processing module for determining whether the input signal is a multi-click signal. The signal processing module determines that the input signal is a multi-click signal while the duration value of several adjacent input signals is less than a preset value. Here, the preset value can be set and tested in accordance with the users' operation habits. The signal processing module can be implemented as the hardware, the firmware, the software or the combination thereof.

In one embodiment, the fingerprint sensor can further comprise the aforementioned keypad structure 104. The pressed signal from pressing the keypad structure 104 may be used as the mode switching hotkey. The keypad structure 104 can be a mechanical keypad or a thin film keypad.

In the embodiment 20, the operation modes can include a fingerprint recognition mode, a scrolling mode, zooming in/out mode or cursor mode.

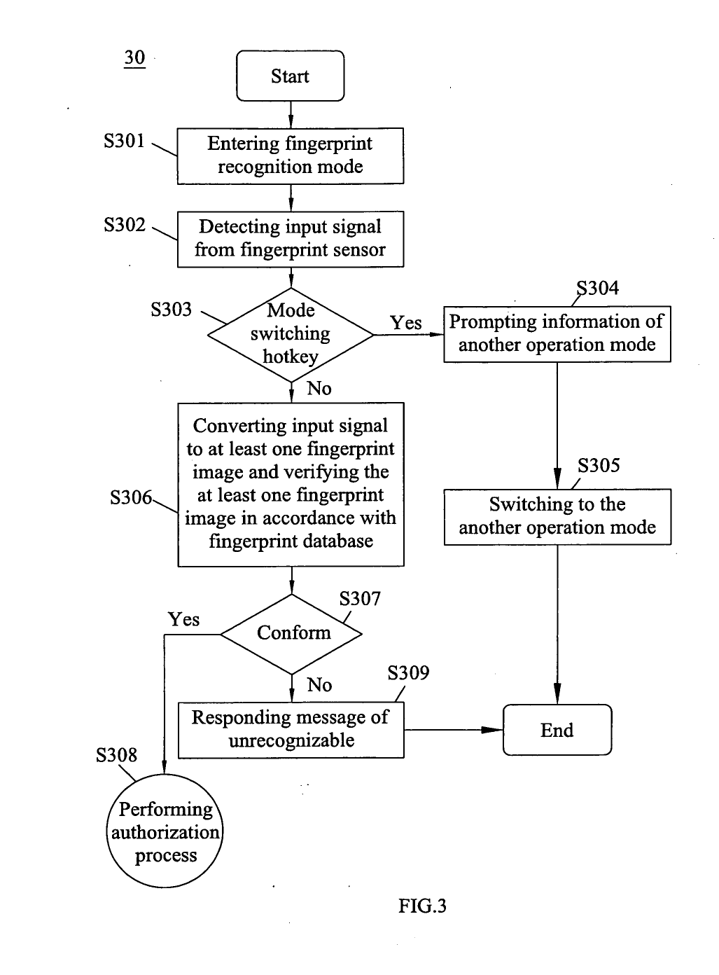

FIG. 3 illustrates a fingerprint recognition mode flow diagram of the method for switching among a plurality of operation modes of a fingerprint sensor in accordance with a preferred embodiment of the present invention. The way to perform the fingerprint recognition module of embodiment 30 comprises the following steps. In step S301, the fingerprint sensor enters a recognition mode which is set as the preset operation mode. In step S302, an input signal is detected by the fingerprint sensor, and the input signal is then determined whether or not the input signal is a mode switching hotkey, in step 303. If the input signal is a mode switching hotkey, the information of another operation mode is prompted to notify the user in step S304, and the fingerprint sensor is then switched to the another operation mode, such as a scrolling mode, the cursor mode or zooming in/out mode, in step S305, and this operation mode is end.

If the input signal is not a mode switching hotkey, the input signal is converted to at least one fingerprint image which is then compared with a fingerprint database in step S306, in order to determine whether or not the fingerprint image matches with the data stored in the database in step S307. If the fingerprint image matches the database, an authorization process is performed in step S308 and this operation mode is end. If the fingerprint image does not match any data stored in the database, a message of un-recognizable is responded in step S309, and this operation mode is end.

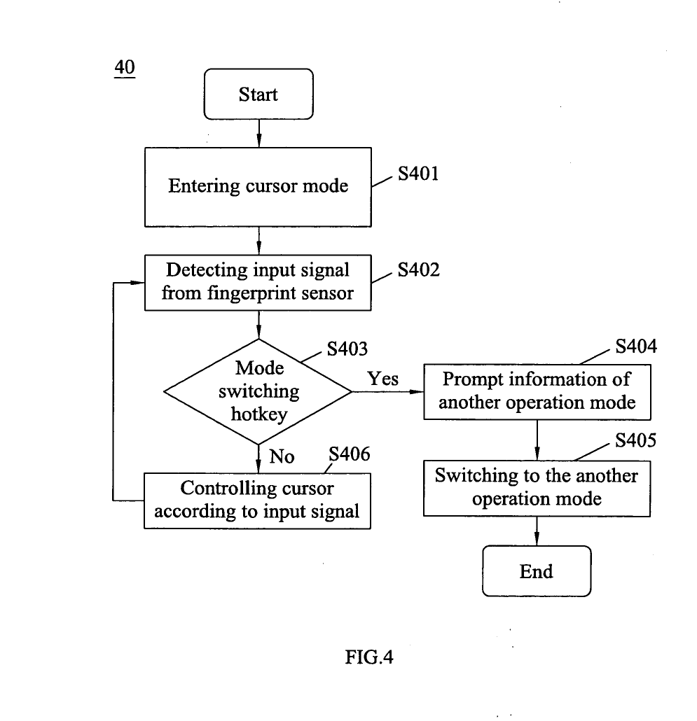

Please refer to FIG. 4 in which a cursor mode flow diagram of the method for switching among a plurality of operation modes of a fingerprint sensor in accordance with a preferred embodiment of the present invention is shown. The way to perform the cursor mode 40 of the embodiment comprises the following steps.

In step S401, the fingerprint sensor enters the cursor mode which is set as the preset operation mode. In step S402, an input signal is detected by the fingerprint sensor, and the input signal is then determined whether or not the input signal is a mode switching hotkey, in step S403.

If the input signal is a mode switching hotkey, the information of another operation mode is prompted by a screen or a speaker in step S404, and the fingerprint sensor switched to the another operation mode, such as a fingerprint recognition mode, scrolling mode or zooming in/out mode, and this operation mode is end.

If the input signal is not a mode switching hotkey, the input signal is converted to at least one fingerprint image which is then applied for controlling the cursor in step S406, and then the step S402 is executed again.

In the cursor mode 40, the way to move the cursor is based on the fingerprint moving direction and distance identified from the plurality of fingerprint images. Or, it can be based on the fingerprint slide movement direction identified from the plurality of fingerprint images. In accordance with the direction to repeatedly move the cursor, the repeating function thus can be achieved.

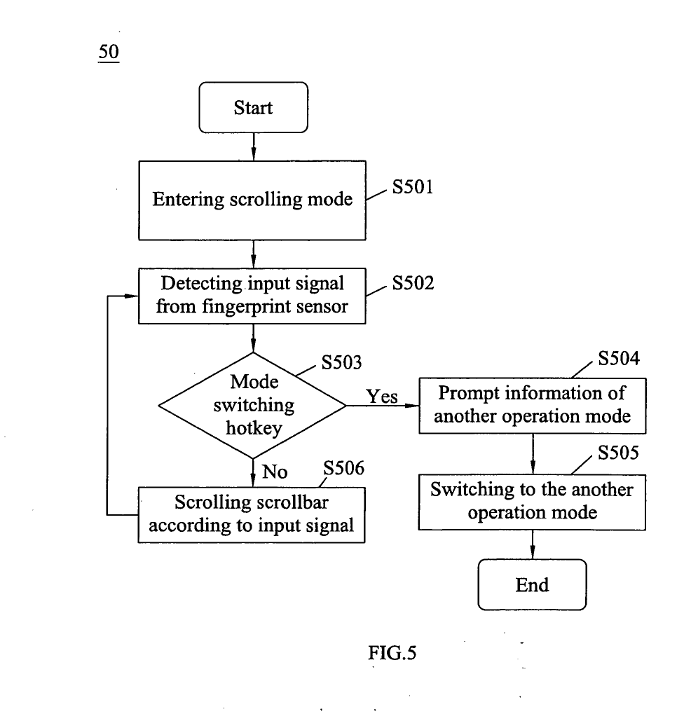

Please Refer to FIG. 5, in which a scrolling mode flow diagram of the method for switching among a plurality of operation modes of a fingerprint sensor in accordance with a preferred embodiment of the present invention is shown. The way to perform the scrolling mode of embodiment comprises the following steps:

In step S501, the fingerprint sensor enters the scrolling mode which is set as the preset operation mode. In step S502 an input signal is detected by the fingerprint sensor and the input signal is determined whether or not the input signal is a mode switching hotkey in step 503. If the input signal is a mode switching hotkey, the information of another operation mode is prompted in step S504, and the fingerprint sensor is switched to another operation mode, such as the fingerprint recognition mode, cursor mode or zooming in/out mode, in step S505, and this operation mode is end.

If the input signal is not a mode switching hotkey, the input signal is converted to at least one fingerprint image and the scrollbar is scrolled according to the at least one fingerprint image in step S506, then the step S502 is executed again for waiting another input signal.

In the scrolling mode 50, the way to control the scrollbar is based on the fingerprint moving direction and distance identified from the plurality of fingerprint images. Or, it can be based on the fingerprint slide movement direction identified from the plurality of fingerprint images. In accordance with the direction to repeatedly move the cursor, the repeating function thus can be achieved.

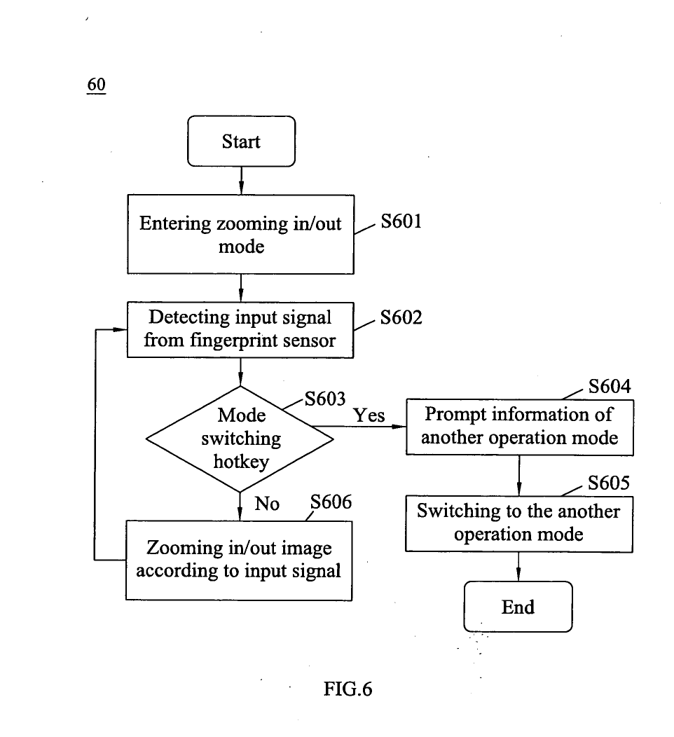

Please refer to FIG. 6, in which a zooming in/out mode flow diagram of the method for switching among a plurality of operation modes of a fingerprint sensor in accordance with a preferred embodiment of the present invention is shown. The way to perform the zooming in/out mode of embodiment comprises the following steps. In step S601, the fingerprint sensor enters the zooming in/out mode which is set as the preset operation mode. In step S602, an input signal is detected from the fingerprint sensor and the input signal is determined whether or not the input signal is a mode switching hotkey in step S603.

If the input signal is a mode switching hotkey, the information of another operation mode is prompted by a screen or a speaker in step S604, and the fingerprint sensor is switched to the another operation mode in step S605, and this operation mode is end.

If the input signal is not a mode switching hotkey, the input signal is converted to at least one fingerprint image which is applied for zooming in/out a displayed image in step S606, and then the step S602 is executed again for waiting another input signal.

In the zooming in/out mode 60, the way to zoom in/out the image is based on the fingerprint slide movement direction identified from the plurality of fingerprint images. The level to zoom in/out the image may be based on the distance of the fingerprint slide movement identified from the plurality of fingerprint images.

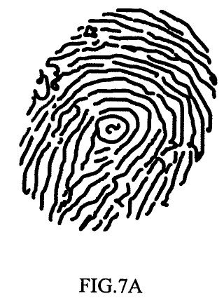

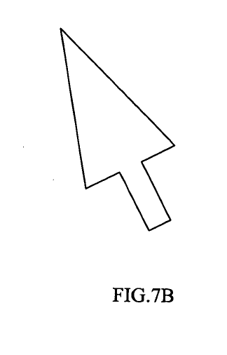

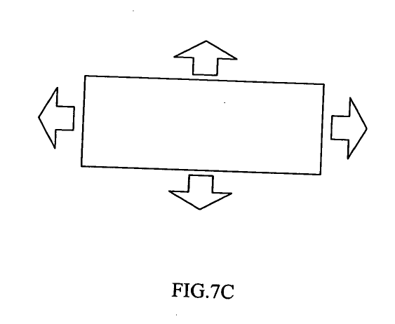

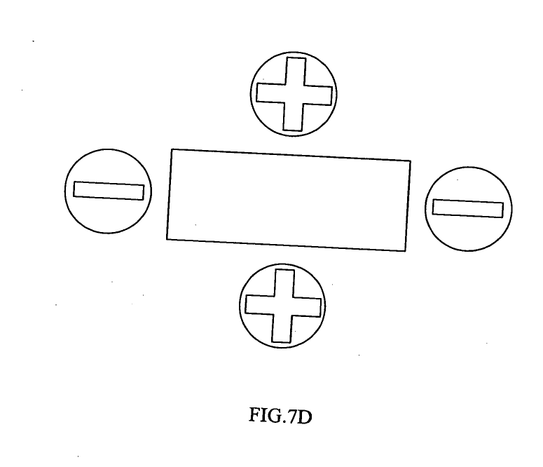

In the embodiment 20, an on screen display (OSD) is used to prompt the information of another operation mode. Each of the plurality of operation modes has its own information, i.e., status message. The status message can be a corresponding text or pattern. Users can understand the function the operation mode in accordance with the text or pattern. Please Refer to FIG. 7A for a pattern related to a fingerprint recognition mode in accordance with a preferred embodiment of the present invention. Please refer to FIG. 7B for a pattern related to a cursor mode in accordance with a preferred embodiment of the present invention. Please Refer to FIG. 7C for a pattern related to a scrolling mode in accordance with a preferred embodiment of the present invention and please refer to FIG. 7D for a pattern related to a zooming in/out mode in accordance with a preferred embodiment of the present invention.

The aforementioned fingerprint sensor may be applicable to any kind of electronic apparatus, such as the desk computer, the industrial computer, the laptop, the mobile communication device (ex: mobile phone), the portable apparatus (ex: personal digital assistant). The electronic apparatus comprises an operating system and a fingerprint sensor. The fingerprint sensor has a plurality of operation modes to operate the operating system. The fingerprint sensor comprises: a fingerprint sensing module for sensing the fingerprint and for generating an input signal; and a keypad structure, disposed below the fingerprint sensing module, for generating a pressed signal when the keypad structure is pressed by an external force; wherein the pressed signal is a mode switching hotkey for switching among the plurality of operation modes.

The operating system can be implemented as the hardware, the firmware, the software or the combination thereof. The finger sensor may be an optical sensing module or a chip based sensing module. The chip based sensing module can be a capacitance sensor, a pressure sensor, a capacitance-pressure sensor, or a temperature-difference sensor. The fingerprint sensor can further comprise a signal processing module for determining whether the input signal is a multi-click signal. The signal processing module can detect the duration for several adjacent input signals which is less than a preset value to determine whether the input signal is a multi-click signal. If the input signal is a multi-click signal, the fingerprint apparatus may switch among the plurality of operation modes.

While the invention has been described in terms of specific embodiments of the present invention, it is not limited to such detail since numerous modifications and variations could be made thereto by those skilled in the art without departing from the scope and spirit of the present invention. Therefore, the features and advantages of the present invention will be set forth in the claims

What is claimed is:

1. A method for switching among a plurality of operation modes of a fingerprint sensor, comprising the steps of:
activating said fingerprint sensor;
switching to one of the plurality of operation modes as a current operation mode of said fingerprint sensor according to a default operation mode setting;
detecting an input signal from said fingerprint sensor; and
switching to another one of the plurality of operation modes as a new current operation mode of said fingerprint sensor when the input signal is a mode switching hotkey.

2. The switching method of claim 1, wherein said mode switching hotkey comprises a multi-click signal.

3. The switching method of claim 1, wherein said fingerprint sensor comprises a keypad structure, and said mode switching hotkey comprises a signal generated by pressing said keypad structure.

4. The switching method of claim 1, wherein said plurality of operation modes include a fingerprint recognition mode capable of recognizing fingerprints, in which the method further comprising the steps of:
converting said input signal into at least one fingerprint image;
verifying said at least one fingerprint image in accordance with a fingerprint database; and
performing an authorization process when said at least one fingerprint image conforms to said fingerprint database.

5. The switching method of claim 1, wherein said plurality of operation modes comprise a cursor mode capable of controlling a cursor, in which the method further comprising the steps of:
converting said input signal into at least one fingerprint image; and
controlling said cursor according to said at least one fingerprint image.

6. The switching method of claim 1, wherein said plurality of operation modes include a scrolling mode capable of controlling a scrollbar, in which the method further comprising the steps of:
converting said input signal into at least one fingerprint image; and
controlling the scrollbar according to said at least one fingerprint image.

7. The switching method of claim 1, wherein said plurality of operation modes comprise a zooming in/out mode capable of zooming in/out a image, in which the method further comprising the steps of:
converting said input signal into at least one fingerprint image; and
zooming in/out said image according to said at least one fingerprint image.

8. The switching method of claim 1, further comprising an on screen display (OSD) to prompt information of said another operation mode before switching to said another operation mode, and each of said plurality of operation modes has a corresponding text or pattern regarded as said information.

9. A fingerprint sensor, comprising:
a fingerprint sensing module for sensing said fingerprint and for generating an input signal; and
a keypad structure, disposed below said fingerprint sensing module, for generating a pressed signal when said keypad structure is pressed by an external force;
wherein said fingerprint sensor has a plurality of operation modes, and said pressed signal is used as a mode switching hotkey for switching among said plurality of operation modes.

10. The fingerprint sensor of claim 9, wherein said operation modes comprise a fingerprint recognition mode, wherein in said fingerprint recognition mode, said input signal is converted into at least one fingerprint image and an authorization process is performed when said at least one fingerprint image conforms to a fingerprint database.

11. The fingerprint sensor of claim 9, wherein said plurality of operation modes comprise a cursor mode for controlling a cursor, wherein in said cursor mode, said input signal is converted into at least one fingerprint image and said cursor is controlled according to said at least one fingerprint image.

12. The fingerprint sensor of claim 9, wherein said plurality of operation modes comprise a scrolling mode for scrolling a scrollbar, wherein in said scrolling mode, said input signal is converted into at least one fingerprint image and the scrollbar is controlled according to said at least one fingerprint image.

13. The fingerprint sensor of claim 9, wherein said plurality of operation modes comprise a zooming in/out mode for zooming in/out an image, wherein in said zooming in/out mode. said input signal is converted into at least one fingerprint image and said image is zoomed in/out according to said at least one fingerprint image.

14. A fingerprint sensor having a plurality of operation modes, comprising:
a fingerprint sensing module for sensing a fingerprint and for generating an input signal; and
a signal processing module, for determining whether said input signal is a multi-click signal;
wherein when said input signal is the multi-click signal, said fingerprint sensor switches among said plurality of operation modes.

15. The fingerprint sensor of claim 14, wherein said plurality of operation modes comprises a fingerprint recognition mode, wherein in said fingerprint recognition mode, said input signal is converted into at least one fingerprint image and an authorization process is performed when said at least one fingerprint image conforms to a fingerprint database.

16. The fingerprint sensor of claim 14, wherein said plurality of operation modes comprises a cursor mode to control a cursor, wherein in said cursor mode, said input signal is converted into at least one fingerprint image and said cursor is controlled according to said at least one fingerprint image.

17. The fingerprint sensor of claim 14, wherein said plurality of operation modes comprises a scrolling mode to scroll a scrollbar, wherein in said scrolling mode, said input signal is converted into at least one fingerprint image and the scrollbar is controlled according to said at least one fingerprint image.

18. The fingerprint sensor of claim 14, wherein said plurality of operation modes comprises a zooming in/out mode to zoom in/out an image, wherein in said zooming in/out mode, said input signal is converted into at least one fingerprint image and said image is zoomed in/out according to said at least one fingerprint image.

19. An electronic apparatus, comprising:
an operating system; and
a fingerprint sensor with a plurality of operation modes to operate said operating system, the fingerprint sensor comprising:
a fingerprint sensing module for sensing said fingerprint and for generating an input signal; and
a keypad structure, disposed below said fingerprint sensing module, for generating a pressed signal when said keypad structure is pressed by an external force;
wherein said pressed signal is used as a mode switching hotkey for switching among said plurality of operation modes.

20. The electronic apparatus of claim 19, wherein said fingerprint sensing module is an optical fingerprint sensing module or a chip based fingerprint sensing module.

21. The electronic apparatus of claim 19, wherein said electronic apparatus uses an on screen display (OSD) to prompt operation mode information, in which each of said plurality of operation mode has a corresponding text or pattern regarded as said operation mode information.

22. The electronic apparatus of claim 19, wherein said plurality of operation modes comprises a fingerprint recognition mode, a cursor mode, a scrolling mode, and a zoom in/out mode.

23. An electronic apparatus, comprising:
an operating system; and
a fingerprint sensor with a plurality of operation modes, the fingerprint sensor comprising:
a fingerprint sensing module for sensing said fingerprint and for generating an input signal; and
a signal processing module, for detecting weather said input signal is a multi-click signal or not;
wherein when said input signal is the multi-click signal, said fingerprint sensor switches among said plurality of operation modes.

24. The electronic apparatus of claim 23, wherein said fingerprint sensing module is an optical fingerprint sensing module or a chip based fingerprint sensing module.

25. The electronic apparatus of claim 23, wherein said electronic apparatus uses an on screen display (OSD) to prompt operation mode information, in which each of said plurality of operation modes has a corresponding text or pattern regarded as said operation mode information.

26. The electronic apparatus of claim 23, wherein said plurality of operation modes comprises a fingerprint recognition mode, a cursor mode, a scrolling mode, or a zooming in/out mode.
